(19) United States
(12) Patent Application Publication
(10) Pub. No.: US 2006/0010844 A1
(43) Pub. Date: Jan. 19, 2006

(54) Unmanned utility vehicle

(75) Inventor: Paul G. Angott, Bloomfield Hills, MI (US)

Correspondence Address: HOWARD & HOWARD ATTORNEYS, P.C., THE PINEHURST OFFICE CENTER, SUITE #101, 39400 WOODWARD AVENUE, BLOOMFIELD HILLS, MI, 48304-5151, US

(73) Assignee: Self Guided Systems, L.L.C., Rochester Hills, MI (US)

(21) Appl. No.: 11/171,693

(22) Filed: Jun. 30, 2005

Related U.S. Application Data
(60) Provisional application No. 60/584,296, filed on Jun. 30, 2004.
(60) Provisional application No. 60/609,309, filed on Sep. 13, 2004.

(51) Int. Cl. A01D 75/30

(52) U.S. Cl. 56/7

(57) ABSTRACT

An unmanned utility vehicle (30) for traversing a plot of land is disclosed that includes a carriage (32) having first and second drive wheels (34, 36) for moving over the plot of land, a guidance assembly (44) for guiding the vehicle (30) about the plot, and at least one tool (46) for performing an operation. The vehicle (30) includes first and second electric drive motors (56, 58) operatively connected to the respective drive wheels (34, 36) and at least one electric tool motor (60) engaging the tool (46). A power supply (64) powers each of the electric drive motors (56, 58) and the electric tool motor (60). Each of the electric motors (56, 58, 60) includes a motor controller operatively connected thereto and in communication with a main controller (54) over a controller area network (86). The subject invention provides each of the motors (56, 58, 60) being modular such that the any electric motor may be connected to the respective controller for performing the required operation.

### CROSS REFERENCE TO RELATED APPLICATION

This application claims the benefit of U.S. Provisional Patent Application Ser. Nos. 60/584,296 filed Jun. 30, 2004 and 60/609,309 filed Sep. 13, 2004.

### BACKGROUND OF THE INVENTION

1. Field of the Invention

The subject invention relates to an unmanned utility vehicle for traversing a plot of land, and more specifically to an unmanned, or autonomous, utility vehicle free of hydraulic and belt drive systems.

2. Description of the Related Art

Various unmanned utility vehicles, such as autonomous lawn mowers, are known to those of ordinary skill in the art and typically include a carriage having a plurality of drive wheels for moving over the plot of land. The drive wheels are driven by an electric motor powered by batteries. The vehicle also includes at least one tool, such as a cutting assembly, supported by the carriage that is powered by an internal combustion engine. In other words, the internal combustion engine is directly engaging and driving the cutting assembly and the electric motors are only driving the drive wheels to propel the vehicle.

One disadvantage of these vehicles is that operation of the internal combustion engines to power the tool is a drain on the internal combustion engine and requires operating the internal combustion engine at various speeds to perform the task. For instance, if the tool is a cutting assembly, the internal combustion engine must operate at different speeds, or revolutions per minute (RPM), in order to cut different thicknesses of grass. The internal combustion engine may operate at lower RPM for thinner grass, but have to operate at higher RPM for thicker grass to prevent stalling of the internal combustion engine. Operating at various RPM uses significantly more gas and also produces different harmonics at each of the different speeds which results in additional noise from the vehicle. Another disadvantage is that if the electrical motors malfunction, the vehicle may continue to operate without the malfimction being detected. When such a malfunction is detected, the complexity of these unmanned systems requires the vehicle to be out of commission for various lengths of time. Further, these systems tend to be quite expensive so additional vehicles are generally not available to continue in place of the malfunctioning vehicle.

Various manned vehicles, such as riding lawn mowers, are known to those of ordinary skill in the art and include the electric drive motors for propelling the vehicle, as well as having electric motors for running the cutting assembly. Since the vehicles are manned, the drive motors must be sufficiently large to accommodate the weight of the operator in addition to the weight of the vehicle. This requires the electric motors to be significantly more powerful and larger to propel the vehicle, which results in heavier vehicles. These heavier vehicles are likely to damage terrain by leaving large ruts or gouges during operation. Another disadvantage is that these electrical motors tend not to be modular, such that if one of the motors malfimctions or breaks, a new motor specific for such operation must be utilized on the vehicle. Said another way, the electrical motors of these manned vehicles generally are not modular.

### SUMMARY OF THE INVENTION AND ADVANTAGES

The subject invention provides an unmanned utility vehicle for traversing a plot of land. The vehicle comprises a carriage having first and second drive wheels for moving over the plot of land and first and second electric drive motors operatively connected to first and second drive wheels. A first drive motor controller is operatively connected to the first electric drive motor and a second drive motor controller is operatively connected to the second electric drive motor. The vehicle also comprises at least one tool supported by the carriage for operation, at least one electric tool motor engaging the tool and supported by the carriage, and a tool motor controller operatively connected to the electric tool motor. A power supply is supported by the carriage for powering each of the electric drive motors and the electric tool motor. A main controller communicates with the drive motor controllers and the tool motor controller to control the electric drive and tool motors. A controller area network interconnects the main controller, the drive motor controllers, and the tool motor controller for facilitating communication therebetween to improve operation and modularity of the vehicle.

Another embodiment of the subject invention provides an autonomous lawn mower that comprises a carriage, a guidance assembly supported by the carriage for navigating the vehicle, and first and second electric drive motors connected to first and second drive wheels. A first drive motor controller is operatively connected to the first electric drive motor and a second drive motor controller is operatively connected to the second electric drive motor. The lawn mower further comprises at least one mower deck supported by the carriage and at least one electric mower deck motor engaging the mower deck. A mower deck motor controller is operatively connected to the electric mower deck motor. A main controller communicates with the guidance assembly, the drive motor controllers and the mower deck motor controller to control the electric drive and mower deck motors.

The lawn mower includes a plurality of rechargeable batteries for powering each of the electric drive motors and the electric mower deck motor. An internal combustion engine is used in combination with a generator disposed between the internal combustion engine and the batteries for recharging the batteries. The electric drive and the mower deck motors are brushless electric motors such that the electric drive and the mower deck motors are controlled by the main controller.

In another embodiment, the lawn mower includes a fuel cell for powering each of the electric drive motors and the electric mower deck motor.

The subject invention overcomes the disadvantages that characterized the related art vehicles. Specifically, the subject invention provides a small, lightweight, and energy efficient vehicle. The vehicle is free of any belt or hydraulic systems resulting in a lighter vehicle with reduced potential for damaging the terrain. The vehicle also has a modular design that is able to adjust operation of various electric motors in real time to reduce or eliminate any down time. Further, if any of the motors become inoperable, the modular design allows any other electric motor to be switched for the defective motor and replaced in order to continue operation. Additionally, the subject invention allows for very precise operation of the vehicle and the tool that has not previously been possible with the related art assemblies at a reasonable cost.

### BRIEF DESCRIPTION OF THE DRAWINGS

Other advantages of the present invention will be readily appreciated, as the same becomes better understood by reference to the following detailed description when considered in connection with the accompanying drawings wherein:

FIG. 1 is a top perspective view of an unmanned utility vehicle according to the subject invention;

FIG. 2 is a bottom perspective of the unmanned utility vehicle shown in FIG. 1;

FIG. 3 is a top perspective view of the unmanned utility vehicle shown in FIG. 1 having a cover removed;

FIG. 4A is a top perspective view of one embodiment of a drive assembly, a tool assembly, a lift assembly, and a power supply of the unmanned utility vehicle;

FIG. 4B is a top perspective view of another embodiment of a drive assembly, a tool assembly, a lift assembly, and a power supply of the unmanned utility vehicle;

FIG. 5 is a schematic flowchart of the unmanned utility vehicle;

FIG. 6 is a side view of the drive assembly;

FIG. 7 is a cross-sectional view taken along Line 7-7 shown in FIG. 6;

FIG. 8 is an exploded view of the drive assembly shown in FIG. 6;

FIG. 9 is an exploded view of a drive motor housing including a drive motor and a drive motor controller;

FIG. 10 is a cross-sectional view of the drive motor shown in FIG. 9;

FIG. 11 is an exploded view of the drive motor shown in FIG. 9;

FIG. 12 is an exploded view of a gear assembly shown in FIG. 9;

FIG. 13 is a side view of the tool assembly;

FIG. 14 is a cross-sectional view of the tool assembly shown in FIG. 13;

FIG. 15 is an exploded view of the tool assembly shown in FIG. 13;

FIG. 16 is an exploded view tool motor housing including a tool motor and a tool motor controller;

FIG. 17 is an exploded view of the tool motor shown in FIG. 16;

FIG. 18 is an exploded view of the lift assembly including a lift mechanism and a lift motor housing;

FIG. 19 is an exploded view of the lift mechanism shown in FIG. 18;

FIG. 20 is an exploded view of the lift motor housing including a lift motor and a lift motor controller;

FIG. 21 is a partial sectional view of the power supply shown in FIG. 4;

FIG. 22 is an exploded view of a generator; and

FIG. 23 is a top perspective view of the unmanned utility vehicle having a user interface mounted into the cover.

### DETAILED DESCRIPTION OF THE INVENTION

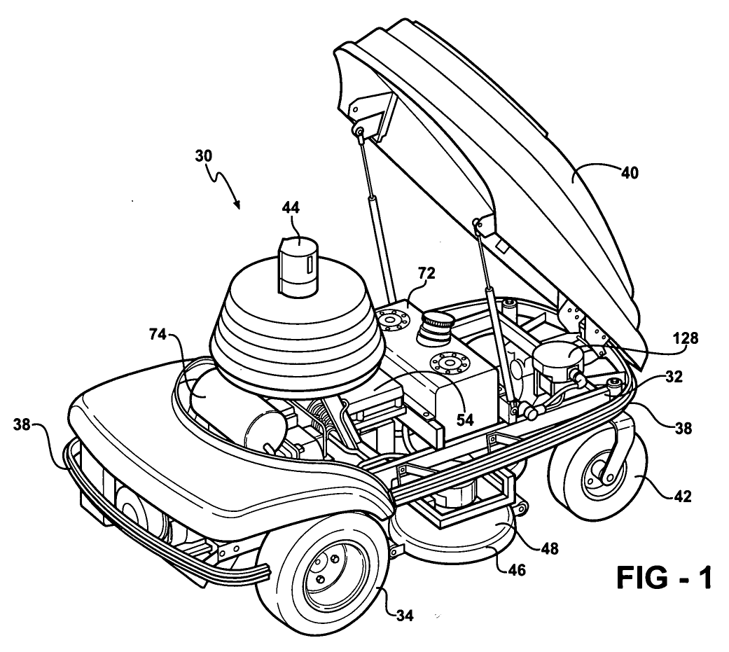

Referring to the Figures, wherein like numerals indicate corresponding parts throughout the several views, an unmanned utility vehicle 30 for traversing a plot of land is shown generally at in FIG. 1. The unmanned utility vehicle 30 may include, but is not limited to, an autonomous lawn mower, vacuum cleaner, sweeper, or scrubber, polisher, sander, or buffer, beach cleaner, ice groomer, or line painter.

The vehicle 30 includes a carriage 32 having first and second drive wheels 34, 36 for moving over the plot of land, a bumper 38, and a cover 40. With reference to FIG. 1, the cover 40 is movable between an open position and a closed position with the cover 40 being shown in the open position. The vehicle 30 may also includes at least one non-drive, or dummy, wheel 42 that is driven by the drive wheels 34, 36. For example, the non-drive wheel 42 may be a caster-type wheel that is capable of swiveling in multiple directions. Alternatively, the vehicle 30 have each of the wheels being driven, i.e., three or more wheels that are driven to improve accuracy.

A guidance assembly 44 is supported by the carriage 32 for guiding the vehicle 30 about the plot. The guidance assembly 44 may be selected from at least one of a laser navigation system, a radio frequency navigation system, a GPS navigation system, and a camera navigation system. The guidance assembly may also include a platform roll pitch controller 43 and a turret rotation controller 45. However, it is to be appreciated that other guidance assemblies 44 may be employed with the subject invention so long as the vehicle 30 is autonomous or unmanned. Such guidance assemblies 44 are disclosed in U.S. Pat. Nos. 6,556,598 and 6,598,692, which are commonly assigned to assignee of the subject invention and which are incorporated herein by reference. As discussed above, the related art assemblies have additional weight due to an operator having to ride the vehicle 30 and due to the vehicle 30 needing to be sufficiently large to support the operator. Since the subject invention is unmanned, the vehicle 30 has lesser weight and does not need to be as heavy, thereby reducing the amount of damage that may be done during operation. Still another advantage is that the vehicle 30 has reduced fuel consumption as well.

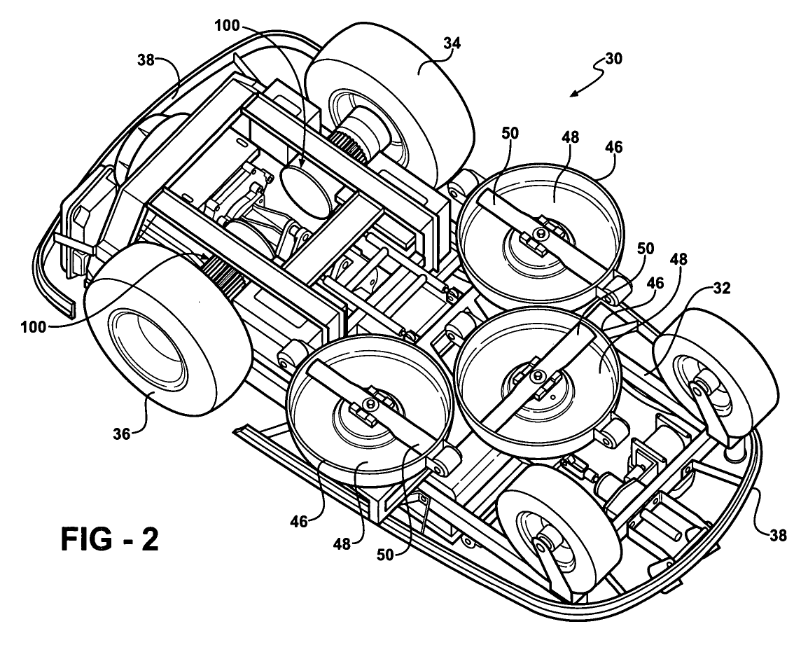

Depending upon the particular type of vehicle 30, the vehicle 30 includes at least one tool 46 supported by the carriage 32 for performing an operation. It is to be appreciated that the tool 46 may be carried by the carriage 32, pulled behind the carriage 32, or pushed in front of the carriage 32. Referring to FIG. 2, the vehicle 30 is illustrated as a lawn mower and the tool 46 is a mower deck having three mower assemblies. The mower deck may have more or fewer decks depending upon a desired width of cut, such as 2 or 5. The mower assemblies include three individual domes 48 that house a blade 50 for mowing and cutting grass. For clarity, the subject invention will be described for use with a lawn mower without limitation. It is to be appreciated that reference numerals may be used in connection with the same component even though the identifier is different, i.e., both the vehicle and lawn mower may be numeral 30 and the tool and mower deck are both numeral 46. However, the tool 46 may be selected from at least one of a mower assembly, a sweeping assembly, a cleaning assembly, and a painting assembly for the particular application. The vehicle 30 may further include an electric lift motor 52 operatively connected to the tool 46 for positioning the tool 46 for use, such as by raising or lowering.

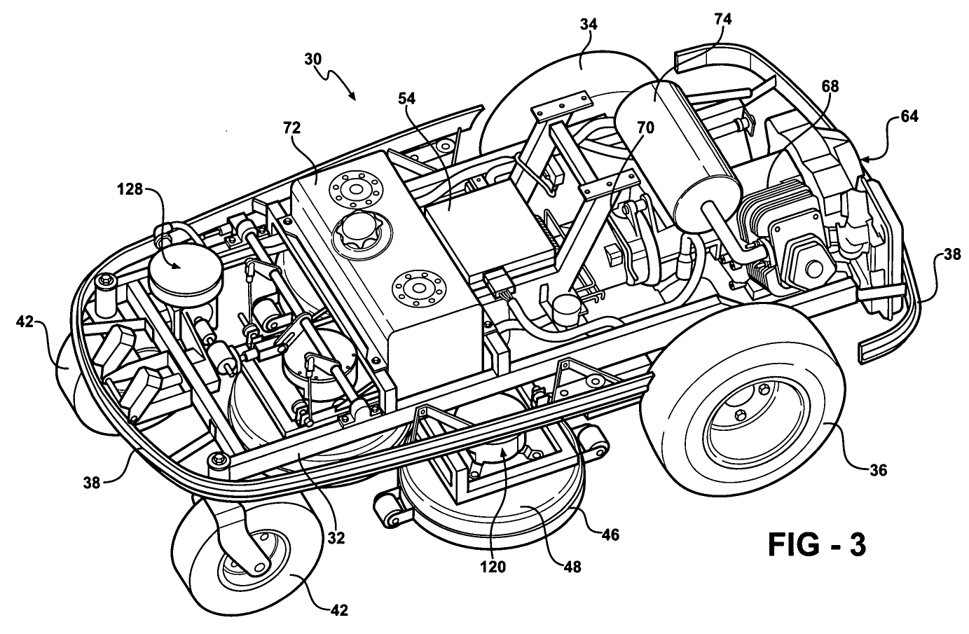

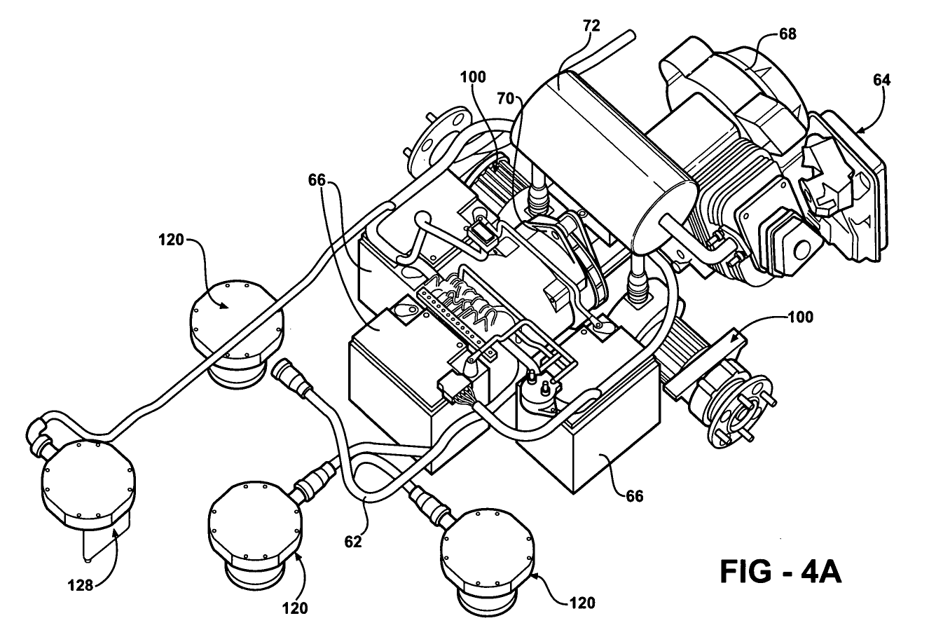

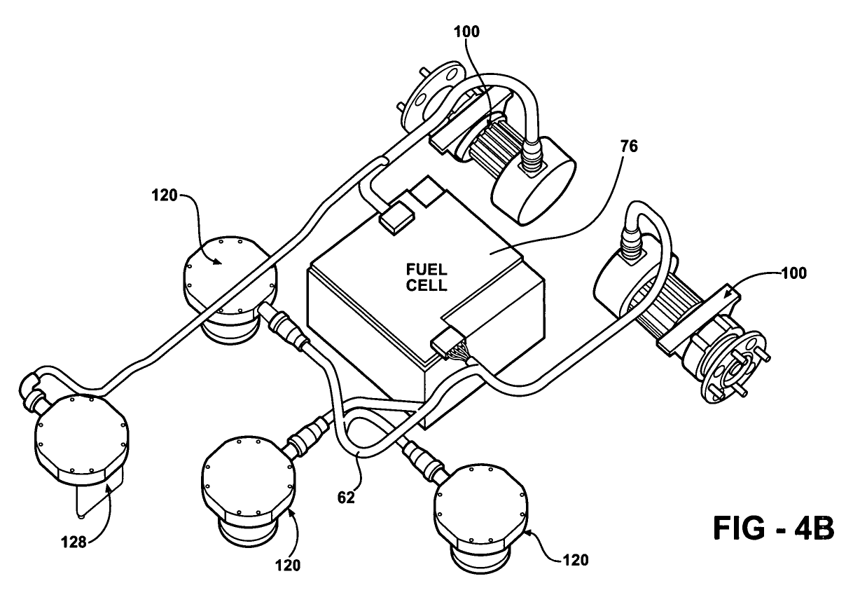

FIG. 3 is a top perspective view of the vehicle 30 having the cover 40 removed. The vehicle 30 includes a main controller 54 for controlling the vehicle 30 as will be described in more detail below. Referring to FIG. 4A, the carriage 32 and cover 40 of the vehicle 30 have been removed to more easily describe the additional components. The vehicle 30 includes a first electric drive motor 56 and a second electric drive motor 58 operatively connected to the first drive wheel 34 and the second drive wheel 36. The vehicle 30 also includes at least one electric tool motor 60 engaging the tool 46 that is also supported by the carriage 32. In FIG. 4A, the vehicle 30 includes three tool motors for driving each of the mower decks. A wiring harness 62 interconnects each of the motors 52, 56, 58, 60 to the main controller 54.

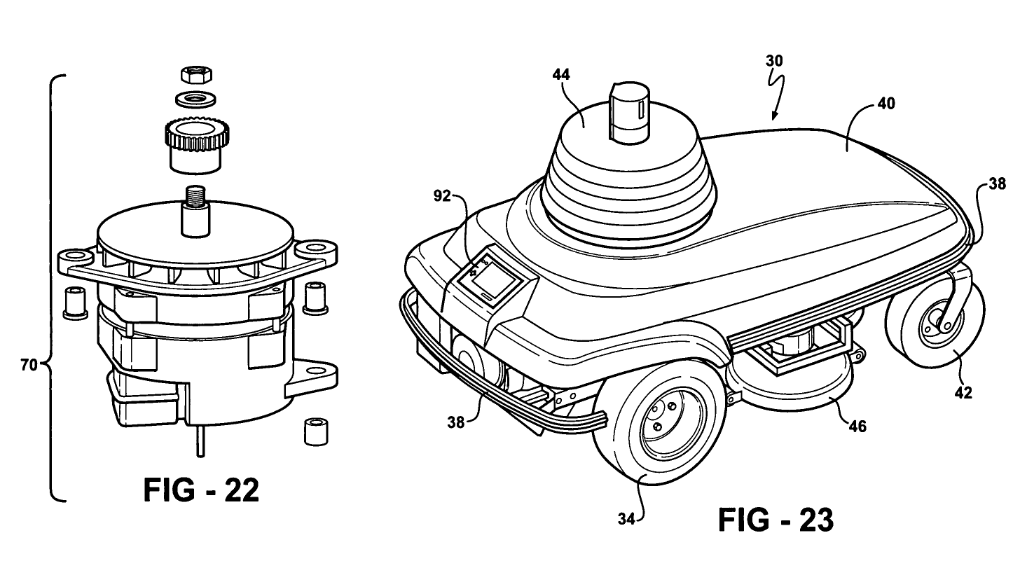

The vehicle 30 further includes a power supply 64 supported by the carriage 32 for powering the electric lift motor 52, the electric drive motors 56, 58, and the electric tool motor 60. In the embodiment shown in FIG. 4A, the power supply 64 comprises a plurality of batteries 66 for running the electric lift motor 52, the electric drive motors 56, 58, and the electric tool motor 60. An internal combustion engine 68 and a generator 70 may be used to charge the batteries 66. An engine controller 87 may be used to monitor the performance of the internal combustion engine 68, the generator 70, and the batteries 66. The batteries 66 may also be used as an electric starter for the internal combustion engine 68. A fuel tank 72 (FIG. 3) stores the fuel for operating the internal combustion engine 68. A side view of the internal combustion engine 68 is shown in FIG. 21. The generator 70 is preferably an alternator and is shown in FIG. 22. Since the internal combustion engine 68 only charges the batteries 66, the internal combustion engine 68 may be operated at a constant revolutions per minute (RPM). One advantage of operating the internal combustion engine 68 at constant RPM is that noise and fuel consumption is reduced. Further, the subject invention includes a muffler 74 connected to the internal combustion engine 68 that muffles a predetermined harmonic. Because the internal combustion engine 68 operates at a nearly constant RPM, the muffler 74 is designed to eliminate the specific harmonic, which results in the vehicle 30 being significantly quieter. Another embodiment of the power supply 64 is illustrated in FIG. 4B. The power supply 64 comprises a fuel cell 76 that powers the electric drive motors 56, 58 and the electric tool motor 60.

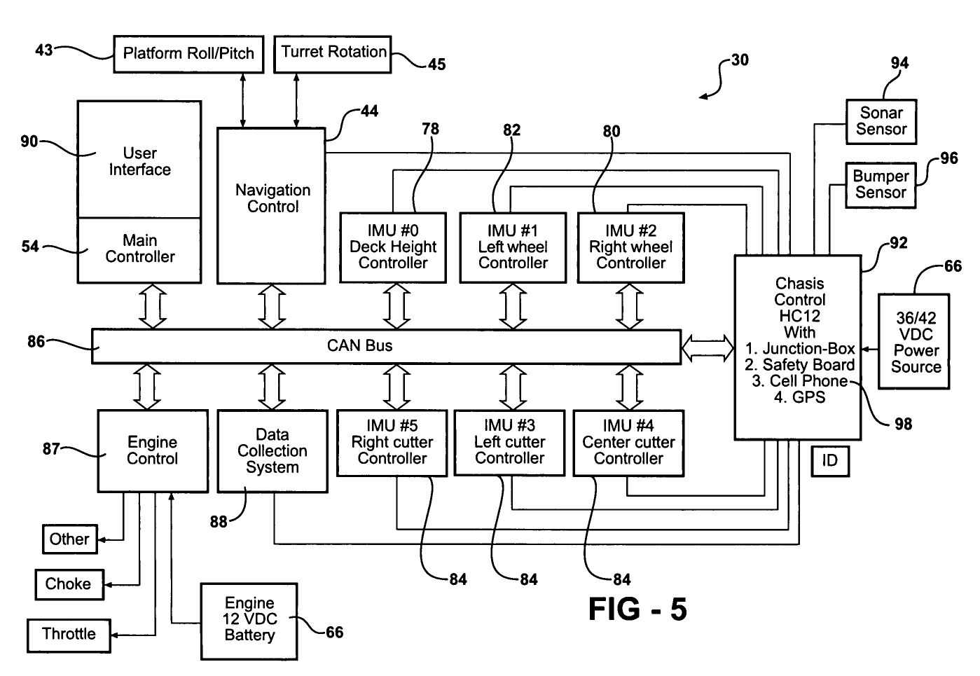

With reference to FIG. 5, a schematic flowchart representing the unmanned utility vehicle 30 is shown. The electric lift motor 52, the electric drive motors 56, 58, and the tool motor 60 are brushless electric motors. Brushless electric motors are typically high endurance and have long run times without requiring maintenance. For example, brushless motors have an operating life of approximately 5,000 to 10,000 hours whereas the brush-type motors have an operating life of about 1,000 to 1,500 hours. Another advantage of the subject invention is that the vehicle 30 is free of belts and hydraulic units for operating such vehicles 30. The belts are replaced by the electric tool motor 60 and the electric drive motors 56, 58 and the hydraulic unit is replaced by the lift motors 52. The brushless motors 52, 56, 58, 60 are also about 30% lighter than the brush-type motors. This is advantageous because the vehicle 30 is lightweight and will not compact the grass that results in a better cut.

Each of the above motors 52, 56, 58, 60 also includes a motor controller operatively connected thereto. For example, a lift motor controller 78 is operatively connected to the lift motor 52, a first drive motor controller 80 is operatively connected to the first electric drive motor 56, a second drive motor controller 82 is operatively connected to the second electric drive motor 58, and a tool motor controller 84 is operatively connected to the electric tool motor 60. As one example, the controllers may include printed circuit boards having the necessary components to receive signals from the main controller 54 through the wiring harness 62 and then interpret the signal from the main controller 54 and generate and transmit a signal to operate the respective motor.

The main controller 54 communicates with the lift motor controller 78, the drive motor controllers 80, 82 and the tool motor controller 84 to control the lift, electric drive, and tool motors. Further, each controller may include a unique identifier to identify the controller and motor to the main controller 54. A controller area network 86, commonly referred to as CAN BUS, interconnects the main controller 54, the drive motor controllers 80, 82, and the tool motor controller 84 for facilitating communication therebetween to improve operation of the vehicle 30. The CAN BUS also communicates with a data collection system 88 for collecting various information relating to each of the motors 52, 56, 58, 60 and a user interfaces 90. A chassis control 92, including a global positioning system receiver, is also in communication with the CAN BUS. Multiple sonar sensors 94 are positioned about the carriage 32 and bumper sensors 96 communicates with the chassis control 92 and with the CAN BUS to provide safety.

In one embodiment, each of the motors 52, 56, 58, 60 may operate using sinusoidal control. To ensure accuracy of the vehicle 30, at least the drive motors 56, 58 should operate using sinusoidal control. The sinusoidal control allows the main controller 54 to precisely control the operation of each of the motors 52, 56, 58, 60. This is particularly advantageous because the movement of the vehicle 30 can be precisely controlled. Another advantage is that the tool motors 60 can be adjusted for varying types and thickness of grass. For example, if the grass is overly thick, then the main controller 54 may operate the tool 46 at a faster RPM, whereas if the grass is a very thin grass, then the tool 46 may operate at a slower speed. The main controller 54 is also able to detect when any one of the tool motors 60 fails. If the tool motor 60 fails, then the main controller 54 recalculates the cutting pattern for the specified area with the remaining tool motors 60. In this manner, the vehicle 30 assembly is still able to complete the cut even if the tool motor 60 fails.

The user interface 90 may be used for programming a route to be followed by the vehicle 30 as best shown in FIG. 23. A remote control (not shown) may also be used to interface with the user interface 90/main controller 54 to program the route into the vehicle 30. The remote control may be a wired module, a wireless module, or both. The user interface 90 may mount into the rear of the cover 40 and may be removable therefrom. Alternatively, the user interface 90 may be permanently formed into the cover 40. The user interface 90 and the main controller 54 may be formed as a single, integral unit removable from the carriage 32. In this manner, the user interface 90 may be used on different vehicles 30, if such vehicles 30 should become inoperable. If multiple vehicles 30 are owned and operated, then the user interface 90 for each one of the vehicles 30 may include relevant information and data about each of the other vehicles 30. For example, the positioning data for achieving various cutting patterns may be stored on each one of the user interfaces 90. If one of the interfaces fails, then any one of the other interfaces may be connected to the vehicles 30 to transfer the information respectively.

The vehicle 30 also includes a communication device 98 supported by the carriage 32 and in communication with the main controller 54 for wirelessly transmitting signals from the vehicle 30 to a base (not shown). The communication device 98 may be used to alert the operator of an error or problem with the vehicle 30. One such communication device 98 is disclosed in copending U.S. patent application Ser. No. 10/179,558 titled “Automatic billing system for a lawn mowing service using GPS”, which is incorporated herein by reference.

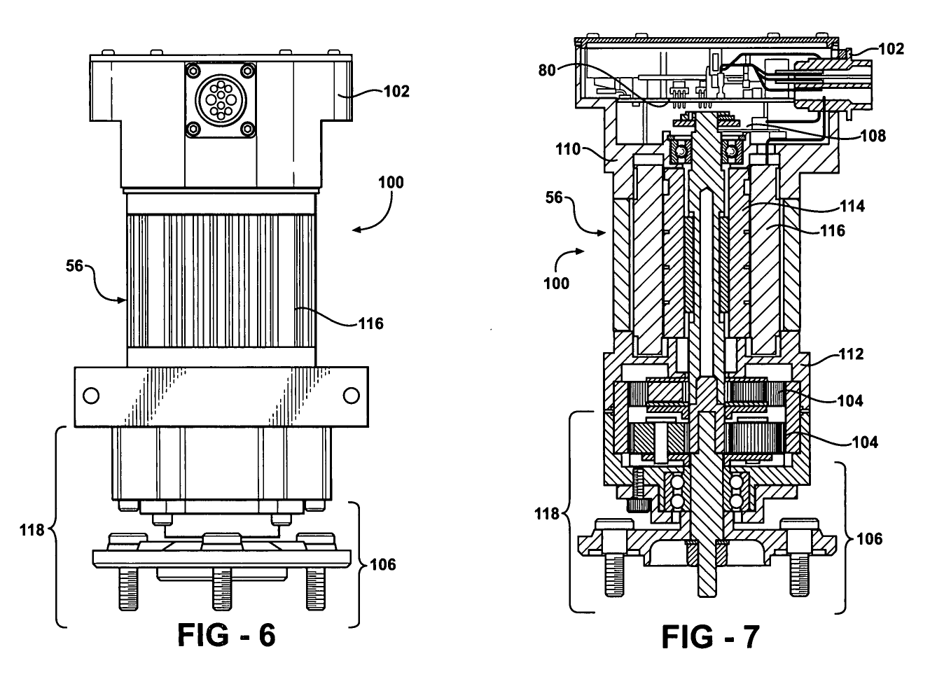

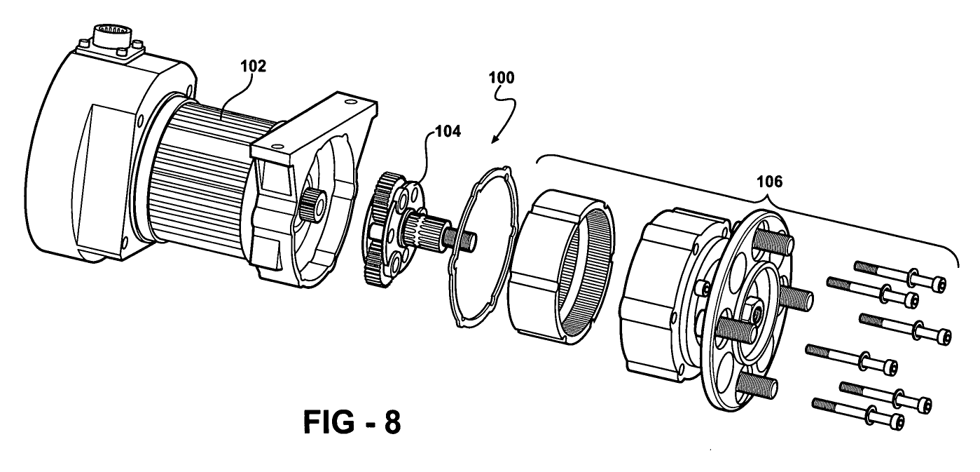

FIG. 6 is a side view of a drive motor assembly 100. The drive motor assembly 100 shown may be for either the first or second drive motors 56, 58. FIG. 7 is a cross-sectional view of the drive motor assembly 100 and FIG. 8 is an exploded view of the drive motor assembly 100. The drive motor assembly 100 includes a drive motor housing 102, a reduction gear assembly 104, and a wheel connector assembly 106. Both of the first and second drive motors 56, 58 and the respective drive motor controllers 80, 82 are disposed in the respective drive motor housings 102. The reduction gear assembly 104, as understood by those of ordinary skill in the art, is used to reduce the relatively high RPM of the electric drive motor to a lower RPM suitable for the drive wheels 34, 36.

The drive motor assemblies 100 are spaced from the main controller 54 such that the main controller 54 communicates with the drive motor controllers 80, 82 via the wiring harness 62. The subject invention provides the vehicle 30 having each of the motors 52, 56, 58, 60 being modular such that if any one of the motors 52, 56, 58, 60 becomes inoperative, any other motor may be substituted in a different motor assembly. The motor controllers 78, 80, 82, 84 drive the motors 52, 56, 58, 60 thereby reducing any maintenance or repair time by being able to switch out one motor for another in a short period of time. Further, the subject invention does not require specialized motors.

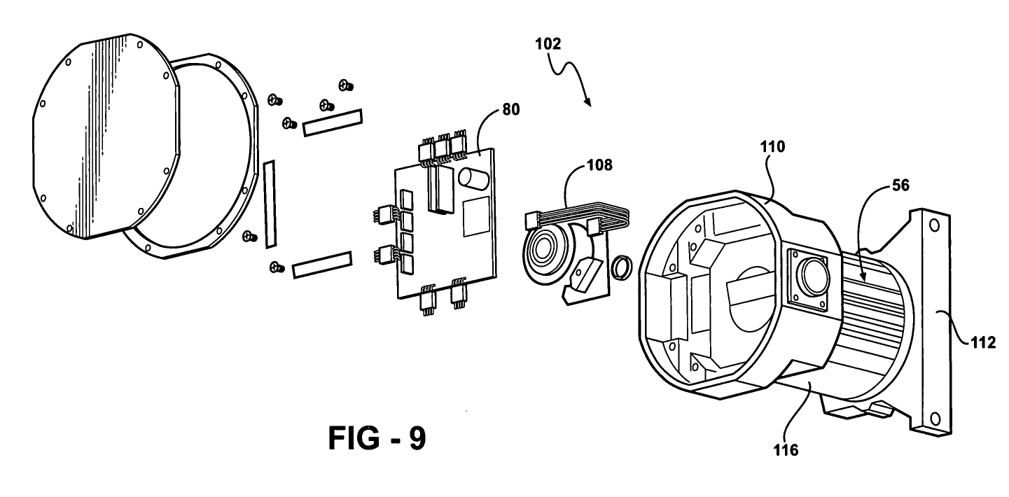

For clarity, the following description is directed toward the first drive motor assembly and it is to be appreciated that the other drive motor assemblies 100 are substantially identical. FIG. 9 is an exploded view of the first drive motor housing 102. The first drive motor housing 102 includes the first drive motor 56, the first drive motor controller 80, and a drive sensor 108 disposed between the first drive motor 56 and the first drive motor controller 78. The drive sensor 108 senses operation of the first drive motor 56 and is used to determine RPM of the first drive motor 56. The drive sensor 108 may be a Hall effect sensor or an optical sensor. For example, the optical sensor emits a beam of light that is blocked by a rotating disc having an opening to allow the light to pass through. Every rotation of the disc is detected by a light detector detecting the light passing through the disc.

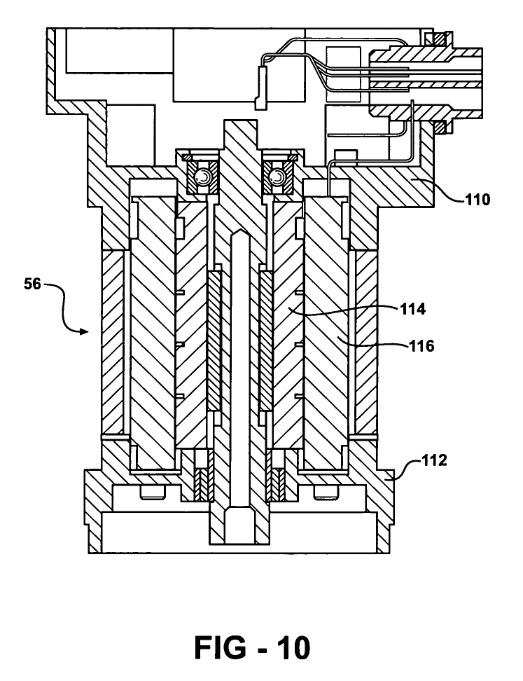

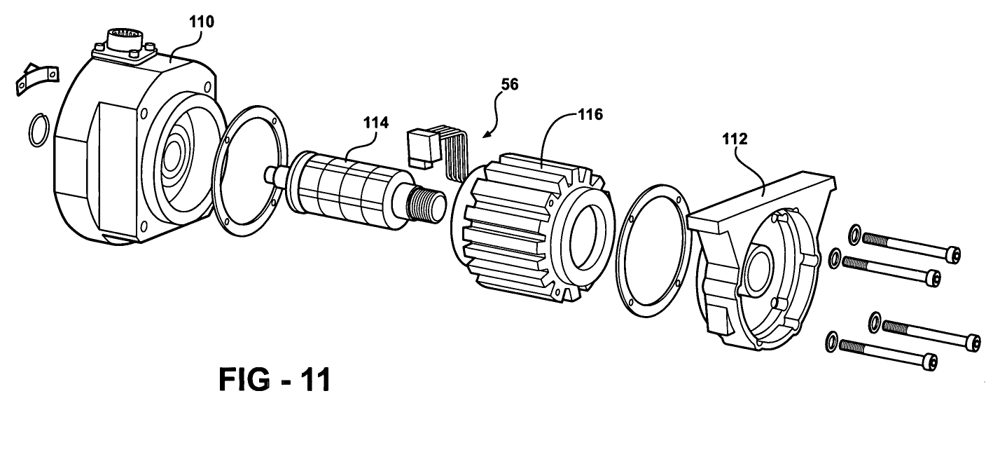

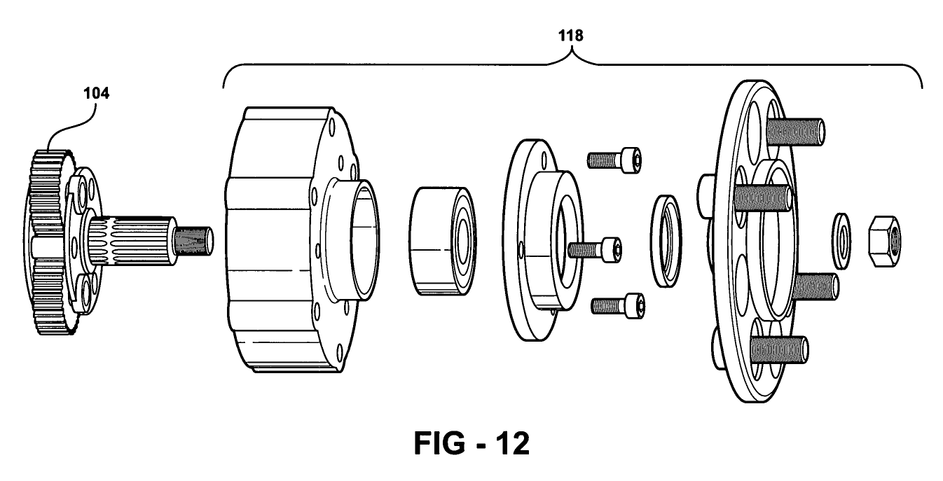

FIG. 10 is a cross-sectional view of the first drive motor 56 and FIG. 11 is an exploded view of the first drive motor 56. The first drive motor 56 includes a main motor housing 110, a motor hub 112, a rotor 114, and a stator 116. As discussed above, each of the motors 52, 56, 58, 60 are preferably brushless motors. The first drive motor controller 80 and drive sensor 108 are housed within the main motor housing 110. FIG. 12 is an exploded view of the wheel connector assembly 106. The wheel connector assembly 106 includes another gear reduction assembly and a drive hub assembly 118. The drive hub assembly 118 connects the drive wheel to the drive motor assembly 100.

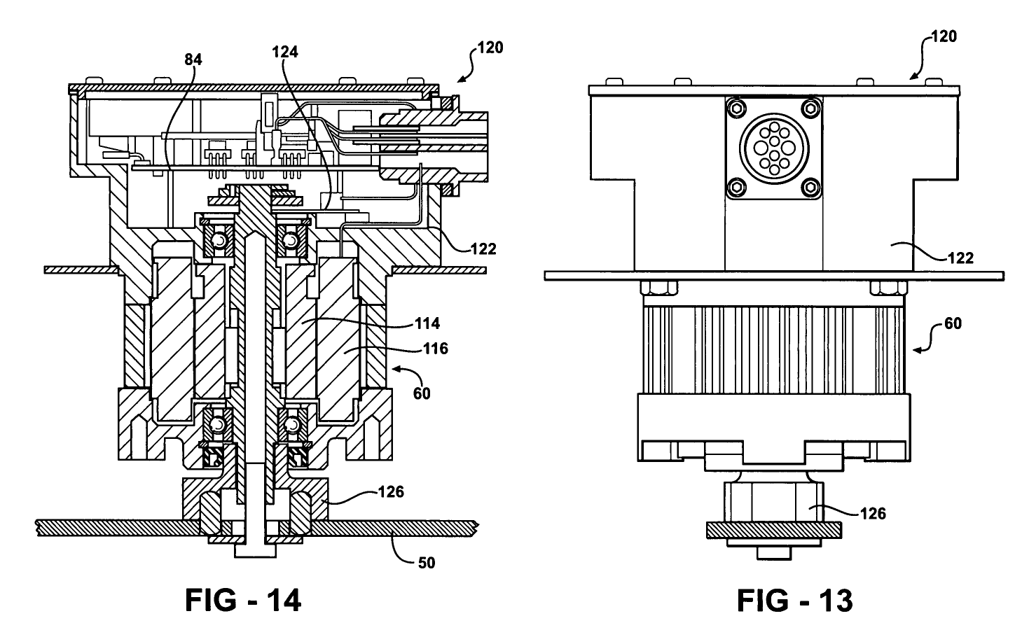

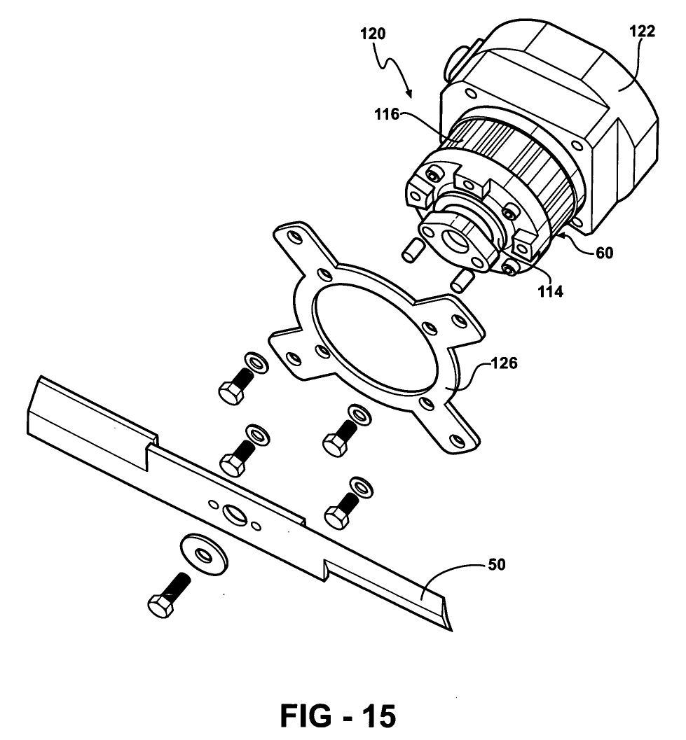

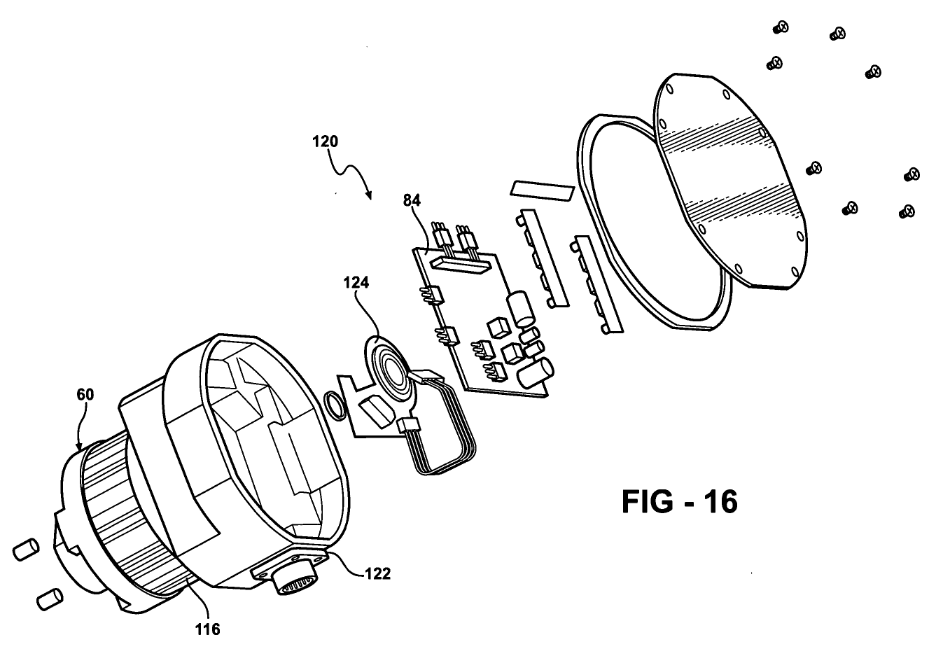

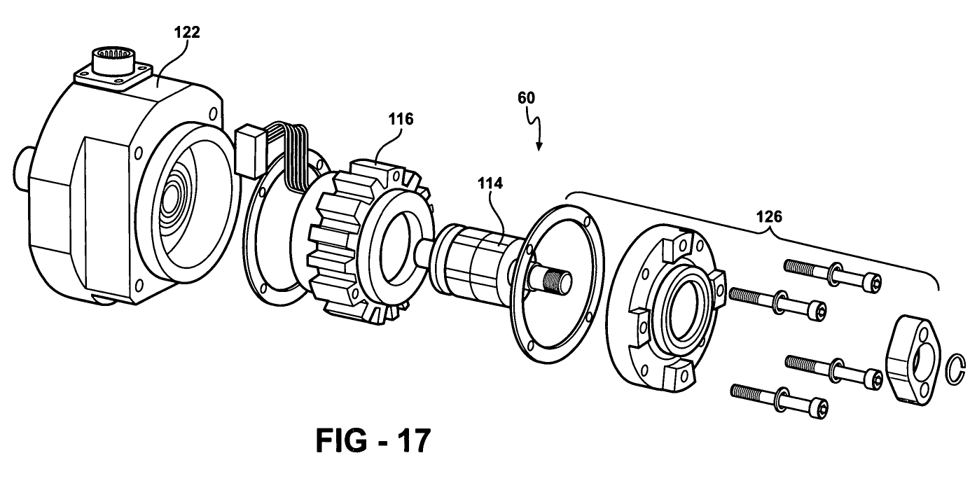

FIG. 13 is a side view of a tool assembly 120 and FIG. 14 is a cross-sectional view of the tool assembly 120. The tool assembly 120 includes a tool housing 122 and the tool 46 mounted thereto as shown in the exploded view of FIG. 15. An exploded view of the tool housing 122 is shown in FIG. 16. The tool housing 122 includes the tool motor 60, the tool motor controller 84 disposed therein, and a tool sensor 124 disposed between the tool motor 60 and the tool motor controller 84. The tool sensor 124 senses operation of the tool motor 60 and is used to determine RPM. The tool sensor 124 may be a Hall effect sensor or an optical sensor, as described above for drive motor assembly 100. The subject invention senses tool, or blade, speed and, when it encounters tall grass, wet grass, or a heavy load, the main controller 54 slows the vehicle 30 down causing the tool motors 60 to operate at the peak of their efficiency curve. This also improves quality of cut because the cutting blades 50 are always cutting through the grass at the correct and optimum speed. FIG. 17 is an exploded view of the tool motor 60 being an electric brushless motor and having the rotor 114 and the stator 116. A tool connector 126 connects to the tool 46 to the tool motor 60.

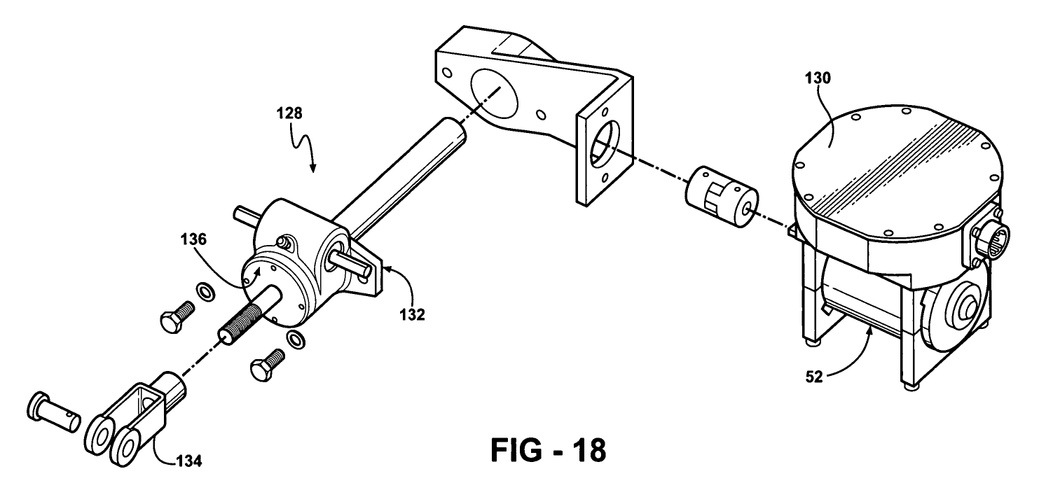

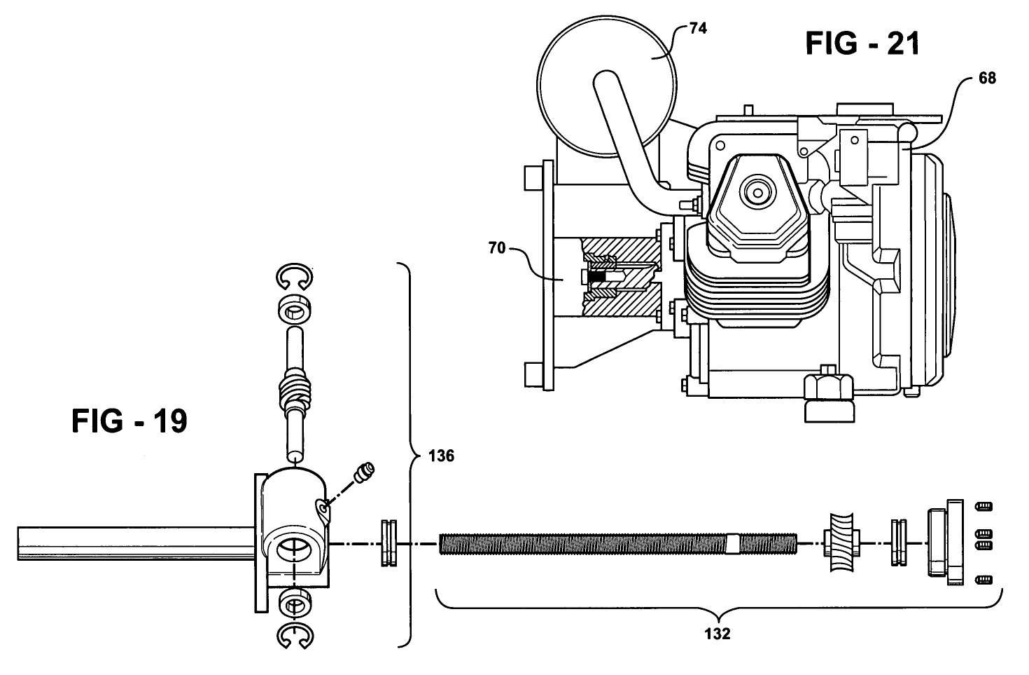

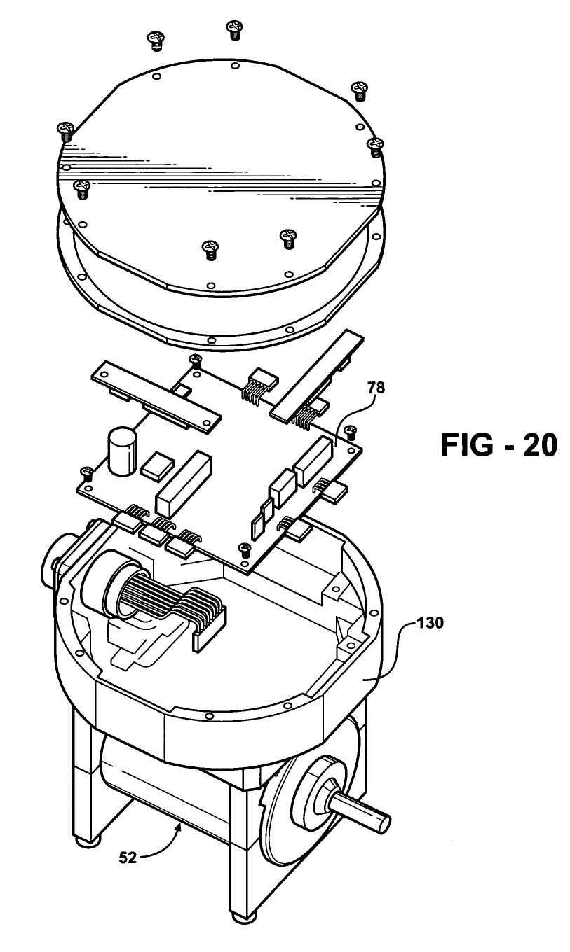

Referring to FIG. 18, a lift assembly 128 is shown and includes a lift motor housing 130 and a lift mechanism 132. The lift mechanism 132 connects the tool 46 to the carriage 32 via a yoke linkage 134. One embodiment of the lift mechanism 132 includes a worm gear assembly 136 shown in FIG. 19. As the lift motor 52 operates, the worm gear assembly 136 raises and lowers the tool 46. FIG. 20 is an exploded view of the lift motor housing 130 having the lift motor 52 and the lift motor controller 78 disposed therein.

The subject invention provides additional advantages such as the vehicle 30 is more energy efficient by a ratio of 3:1 because the vehicle 30 uses small, electric motors 52, 56, 58, 60 that use less power than a gas engine. For exanple, a 360-watt electric motor (Toro battery powered 18-inch mower) can produce the equivalent cutting power of a 5-Horsepower gas engine, or about 3,700 watts (there are about 740 watts per HP). Therefore, the electric motor is more efficient because gas engines that are used have considerably more power than what is actually required to cut grass. Still another advantage of electric motors 52, 56, 58, 60 is that they can temporarily exceed their rated capacity by drawing more current, whereas the gas engine is limited to its rated capacity. In fact, when the gas engine encounters a situation requiring more power than it can produce, it bogs down and becomes less powerful because it slides off its maximum point on the power curve.

While the invention has been described with reference to an exemplary embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims. In addition, the reference numerals in the claims are merely for convenience and are not to be read in any way as limiting.

What is claimed is:

1. An unmanned utility vehicle (30) for traversing a plot of land comprising:
a carriage (32) having first and second drive wheels (34, 36) for moving over the plot of land;
a first electric drive motor (56) and a second electric drive motor (58) operatively connected to said first and second drive wheels (34, 36);
a first drive motor controller (80) operatively connected to said first electric drive motor (56) and a second drive motor controller (82) operatively connected to said second electric drive motor (58);
at least one tool (46) supported by said carriage (32) for performing an operation;
at least one electric tool motor (60) engaging said tool (46) and supported by said carriage (32);
a tool motor controller (84) operatively connected to said electric tool motor (60);
a power supply (64) supported by said carriage (32) for powering each of said electric drive motors (56, 58) and said electric tool motor (60);
a main controller (54) for communicating with said drive motor controllers (80, 82) and said tool motor controller (84) to control said electric drive (56, 58) and tool motors (60); and
a controller area network (86) interconnecting said main controller (54), said drive motor controllers (80, 82), and said tool motor controller (84) for facilitating communication therebetween to improve operation and modularity of said vehicle (30).

2. An unmanned utility vehicle (30) as set forth in claim 1 wherein said electric drive (56, 58) and said tool motors (60) are further defined as brushless electric motors.

3. An unmanned utility vehicle (30) as set forth in claim 1 wherein said tool (46) is further defined as selected from at least one of a mower assembly, a sweeping assembly, a cleaning assembly, and a painting assembly.

4. An unmanned utility vehicle (30) as set forth in claim 1 wherein said power supply (64) further comprises a plurality of batteries (66) for running said electric drive motors (56, 58) and said electric tool motor (60).

5. An unmanned utility vehicle (30) as set forth in claim 4 wherein said power supply (64) further comprises an internal combustion engine (68) and a generator (70) for charging said batteries (66).

6. An unmanned utility vehicle (30) as set forth in claim 5 wherein said internal combustion engine (68) is further defined as operating at a constant revolutions per minute for reducing noise and fuel consumption.

7. An unmanned utility vehicle (30) as set forth in claim 6 further comprising a muffler (74) connected to said internal combustion engine (68) for muffling a predetermined harmonic generated during operation of said internal combustion engine (68) at said constant revolutions per minute.

8. An unmanned utility vehicle (30) as set forth in claim 1 wherein said power supply (64) further comprises a fuel cell (76).

9. An unmanned utility vehicle (30) as set forth in claim 1 further comprising first and second drive motor housings (102) each having said electric drive motor (56, 58) and said drive motor controller (80, 82) disposed therein and spaced from said main controller (54).

10. An unmanned utility vehicle (30) as set forth in claim 1 further comprising a tool housing (122) having said electric tool motor (60) and said tool motor controller (84) disposed therein and spaced from said main controller (54).

11. An unmanned utility vehicle (30) as set forth in claim 1 further comprising an electric lift motor (52) connected to said power supply (64) and operatively connected to said tool (46) for raising and lowering said tool (46).

12. An unmanned utility vehicle (30) as set forth in claim 11 further comprising a lift motor controller (78) operatively connected to said lift motor (52) and in communication with said main controller (54) via said controller area network (86) for controlling operations of said lift motor (52).

13. An unmanned utility vehicle (30) as set forth in claim 1 further comprising a guidance assembly (44) supported by said carriage (32) for communicating with said main controller (54) for guiding said vehicle (30) about the plot.

14. An unmanned utility vehicle (30) as set forth in claim 13 wherein said guidance assembly (44) is further defined as selected from at least one of a laser navigation system, a radio frequency navigation system, a GPS navigation system, and a camera navigation system.

15. An unmanned utility vehicle (30) as set forth in claim 1 further comprising a user interface (90) for programming a route to be followed by said vehicle (30).

16. An unmanned utility vehicle (30) as set forth in claim 15 wherein said user interface (90) and said main controller (54) are further defined as a single, integral unit removable from said carriage (32).

17. An unmanned utility vehicle (30) as set forth in claim 15 further comprising a communication device (98) supported by said carriage (32) and in communication with said main controller (54) for wirelessly transmitting signals from said vehicle (30).

18. An unmanned utility vehicle (30) as set forth in claim 1 further comprising first and second drive sensors (108) disposed between said first and second drive motors (56, 58) and said first and second drive motor controllers (80, 82) for sensing operation of said drive motors (56, 58).

19. An unmanned utility vehicle (30) as set forth in claim 1 firther comprising a tool sensor (124) disposed between said tool motor (60) and said tool motor controller (84) for sensing operation of said tool motor (60).

20. An autonomous lawn mower (30) comprising:
a carriage (32) having first and second drive wheels (34, 36) for moving over a plot of land;
a guidance assembly (44) supported by said carriage (32) for navigating said lawn mower (30) about the plot;
a first electric drive motor (56) and a second electric drive motor (58) connected to said first and second drive wheels (34, 36);
a first drive motor controller (80) operatively connected to said first electric drive motor (56) and a second drive motor controller (82) operatively connected to said second electric drive motor (58);
at least one mower deck (46) supported by said carriage (32) for performing a mowing operation;
at least one electric mower deck motor (60) engaging said mower deck (46) and supported by said carriage (32);
a mower deck motor controller (84) operatively connected to said electric mower deck motor (60);
a main controller (54) for communicating with said guidance assembly (44), said drive motor controllers (80, 82), and said mower deck motor controller (84) to control said electric drive and mower deck motors (56, 58, 60);
a plurality of rechargeable batteries (66) for powering each of said electric drive motors (56, 58) and said electric mower deck motor (60);
an internal combustion engine (68) operating at a constant revolutions per minute for reducing noise and fuel consumption; and
a generator (70) disposed between said internal combustion engine (68) and said batteries (66) for recharging said batteries (66);
wherein said electric drive and said mower deck motors (56, 58, 60) are brushless electric motors such that said electric drive and said mower deck motors (56, 58, 60) are controlled by said main controller (54).

21. An autonomous lawn mower (30) as set forth in claim 20 further comprising a muffler (74) connected to said internal combustion engine (68) for muffling a predetermined harmonic generated during operation of said internal combustion engine (68) at said constant revolutions per minute.

22. An autonomous lawn mower (30) as set forth in claim 20 wherein said guidance assembly (44) is further defined as selected from at least one of a laser navigation system, a radio frequency navigation system, a GPS navigation system, and a camera navigation system.

23. An autonomous lawn mower (30) as set forth in claim 20 further comprising a user interface (90) for programming a route to be followed by said lawn mower (30).

24. An autonomous lawn mower (30) as set forth in claim 23 wherein said user interface (90) and said main controller (54) are further defined as a single, integral unit removable from said carriage (32).

25. An autonomous lawn mower (30) as set forth in claim 23 further comprising a communication device (98) supported by said carriage (32) and in communication with said main controller (54) for wirelessly transmitting signals from said lawn mower (30).

26. An autonomous lawn mower (30) as set forth in claim 20 further comprising a controller area network (86) interconnecting said main controller (54), said drive motor controllers (80, 82), and said mower deck motor controller (84) for facilitating communication therebetween to improve operation of said lawn mower (30).

27. An autonomous lawn mower (30) comprising:
a carriage (32) having first and second drive wheels (34, 36) for moving over a plot of land;
a guidance assembly (44) supported by said carriage (32) for navigating said lawn mower (30) about the plot;
a first electric drive motor (56) and a second electric drive motor (58) connected to said first and second drive wheels (34, 36);
a first drive motor controller (80) operatively connected to said first electric drive motor (56) and a second drive motor controller (82) operatively connected to said second electric drive motor (58);
at least one mower deck (46) supported by said carriage (32) for performing a mowing operation;
at least one electric mower deck motor (60) engaging said mower deck (46) and supported by said carriage (32);
a mower deck motor controller (84) operatively connected to said electric mower deck motor (60);
a main controller (54) for communicating with said guidance assembly (44), said drive motor controllers (80, 82), and said mower deck motor controller (84) to control said electric drive and mower deck motors (56, 58, 60); and
at least one fuel cell (76) connected to said electric motors (56, 58, 60) for powering each of said electric drive motors (56, 58) and said electric mower deck motor (60).

28. An autonomous lawn mower (30) as set forth in claim 27 further comprising a controller area network (86) interconnecting said main controller (54), said drive motor controllers (80, 82), and said mower deck motor controller (84) for facilitating communication therebetween to improve operation of said lawn mower (30).

29. An autonomous lawn mower (30) as set forth in claim 27 wherein said electric drive and said mower deck motors (56, 58, 60) are brushless electric motors such that said electric drive and said mower deck motors (56, 58, 60) are controlled by said main controller (54).
